(19) United States
(12) Patent Application Publication
(10) Pub. No.: US 2007/0229649 A1
(43) Pub. Date: Oct. 4, 2007

(54) Method and Apparatus for Marking an Egg with an Advertisement and Freshness Date

(76) Inventor: Bradley E. Parker, Glen Ridge, NJ (US)

Correspondence Address: GREER, BURNS & CRAIN, 300 S WACKER DR, 25TH FLOOR, CHICAGO, IL, 60606, US

(21) Appl. No.: 10/542,324

(22) PCT Filed: Jan. 12, 2004
(86) PCT No.: PCT/US04/00633

§ 371 Date: Apr. 4, 2007

(30) Foreign Application Priority Data
Jan. 15, 2003 (US) 60440273

(51) Int. Cl. B41J 2/435

(52) U.S. Cl. 347/248

(57) ABSTRACT

An egg is provided with an advertisement and a freshness date upon the egg. The advertisement and freshness date may be applied to the egg with radiant energy. The egg may move through an egg-handling machine through a region where the radiant energy may be applied to the egg. The radiant energy discolors the egg, thereby creating text and graphics, which form the advertisement and freshness date.

### BACKGROUND OF THE INVENTION

The present invention relates to an egg marked with advertisements and a freshness date, and the method and apparatus used to create those eggs.

Advertising on eggs provides a unique medium for advertisers to reach consumers. Attempts have been made to take advantage of this medium of advertising as described in U.S. Pat. No. 4,843,958, to Egosi and titled “Method and Apparatus for Applying Advertisements to Eggs.” However, there is still a need for an easy application of advertising on eggs. There is also a need to put a date on eggs, to ensure customers that the egg is fresh.

The present invention addresses this need. The present invention provides an egg that has both an advertisement and a freshness date applied on it. The freshness date tends to cause the consumer to scrutinize the egg, to confirm that it is fresh. As the consumer looks at the egg, he or she will tend to view the advertisement as well. Thus, providing both the freshness date and the advertisement enhances the efficacy of the advertisement. Moreover, the cost of the marking operation is at least partially offset by the economic value of the advertisement. Further aspects of this invention provide methods and apparatus for applying markings to eggs.

### SUMMARY OF THE INVENTION

One aspect of the present invention includes a method of marking an egg by applying radiant energy to the shell of an egg so as to cause discoloration of the eggshell to form a permanent marking. The markings include text and graphics, and can include an advertisement, a freshness date, or most preferably includes both. A laser may be employed as the radiant energy source. Desirably, the radiant energy is applied so as to leave some areas of the eggshell unaffected so as to form contrast between the unaffected areas and the marking. The method may include forming the markings by the radiant energy while the egg moves in a machine through a predetermined region.

In a particularly preferred method according to the present invention, the markings are made without applying a foreign material to the eggshell that is necessary to help form the marking.

There is provided a method of freshness advertising including an advertisement and a freshness date on an egg. The method may include applying radiant energy to the shell of an egg to discolor the eggshell and form the advertisement and the freshness date. The method may include applying the advertisement and the freshness date in one step.

There is provided an apparatus for applying markings on eggs including an egg-handling machine and a radiant energy source located in proximity to the egg-handling machine, so that the radiant energy source can apply radiant energy to the egg to discolor the eggshell and form the markings. The apparatus does not include any structure for applying a radiant energy sensitive material to the egg. The apparatus may include the egg-handling machine being an egg-grading machine.

A related aspect of the present invention provides methods of modifying existing egg-handling apparatus having a conveyance arranged to move eggs through a predetermined region including placing a radiant energy source in proximity to the egg-handling machine so that radiant energy can come from the radiant energy source and impinge on the eggs moved by the conveyance through the predetermined region. The method may be performed without adding to the egg-handling machine any apparatus for applying a radiant energy sensitive material or other material onto the eggs.

There is provided an egg bearing an information marking on it, wherein the marking is formed at least in part by discolored material on the eggshell. The egg may include the marking being formed entirely by discolored material of the eggshell. The egg may also be raw or pasteurized.

For a better understanding of the present invention, reference is made to the following description, taken in conjunction with the accompanying drawings, and its scope will be pointed out in the appending claims.

### BRIEF DESCRIPTION OF THE DRAWINGS

FIG. 1 is a diagram depicting an egg in accordance with the present invention.

FIG. 2 is a diagram of another view of an egg in accordance with the present invention.

FIG. 3 is a diagram of another view of an egg in accordance with the present invention.

FIG. 4 is a diagram of a top view of an egg in accordance with the present invention.

FIG. 5 is a diagrammatic view depicting a method in accordance with an embodiment of the present invention.

FIG. 6 is a diagrammatic view depicting a method in accordance with another embodiment of the present invention.

FIG. 7 is a diagrammatic view depicting a method in accordance with another embodiment of the present invention.

FIG. 8 is a block diagram depicting locations of inline and offline application of the present invention.

FIG. 9 is a diagrammatic view depicting a method in accordance with another embodiment of the present invention.

### DETAILED DESCRIPTION

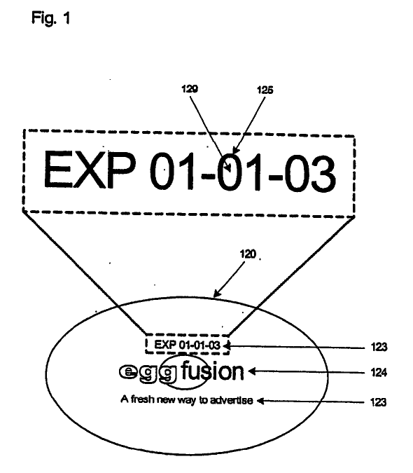

Referring to FIG. 1, an egg 120 is provided with markings. The markings include text 123 and graphics 124. The markings are formed by completely discoloring material of the shell to form text 123 and graphics 124, or by discoloring some material of the shell 125 and leaving other areas of the shell unaffected 129. The discoloration may also be done variably so as to form a gradient of discoloration to form the graphics 124, or to create a variety of text 123 such as bold text, italic text, or any type of text font. That is, some areas may be more discolored than others as, for example, by exposing them to radiant energy for a higher intensity or longer duration than other areas. The egg itself preferably is a raw chicken egg, although other edible raw eggs such as, duck, goose or ostrich eggs can be used. Also, the markings on can be applied to precooked eggs, as for example, boiled or microwaved eggs.

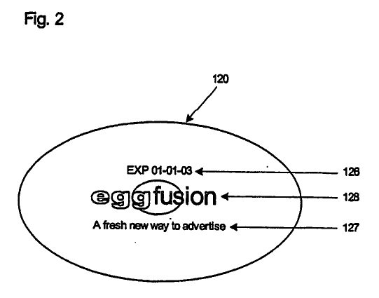

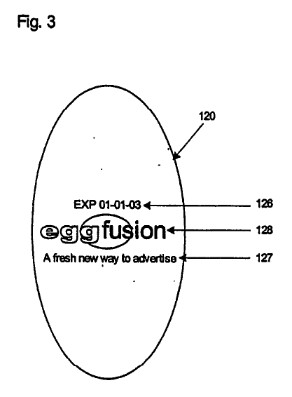

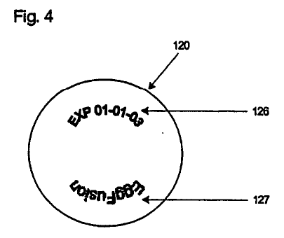

The text and graphics may be applied horizontally (FIG. 2), vertically (FIG. 3), or on top (FIG. 4) of egg 120. The text and graphic discolorations can be controlled to form a freshness date 126 and an advertisement. The freshness date 126 may also include a trace ability code to identify the origin of the egg. The advertisement includes a tag line 127 or a logo 128. Most preferably, egg 120 includes a freshness date 126, a tag line 127, and a logo 128. The freshness date 126 is provided to reassure consumers about the expiration date of the particular egg 120. The trace ability code provides detailed information regarding the location of where the egg was produced in order to assist in consumer alerts. The advertisement, comprised of tag line 127 and logo 128, may include a trademark, slogan, or any other promotional text or graphics affiliated with conveying information for advertising.

Radiant energy as, for example, electromagnetic radiation such as visible, infrared or ultraviolet light, can be used to discolor the eggshell. The radiant energy can be controlled to only discolor a targeted print area 125 of the eggshell. Some areas of the egg can be left unaffected 129 (see FIG. 1). The discoloration on the eggshell is easily viewable because of the contrast of the eggshell color 129 to the discoloration 125 from the radiant energy. The discoloration 125 can be used to form information on the eggs. Also, the discoloration 125 in combination with the unaffected area 129 can be used to form information. This information includes text and graphics. The discoloration to form text and graphics can be applied in one step by a radiant energy source. The information-bearing eggs can be used to convey advertisements, including a logo and a tag line, and a freshness date.

No foreign material must be added to the eggshell in order for the radiant energy to discolor the eggshell. Thus, no foreign material such as any ink or radiant energy sensitive material that could react with the radiant energy needs to be added to form a marking. The radiant energy is applied to the natural eggshell. While foreign materials may be applied for other purposes as, for example, water used to wash the shells or the like, such foreign materials desirably do not play a role in formation of the markings. Thus, the marking most desirably is formed solely by the effect of the radiant energy on the normally occurring materials of the eggshell itself. This provides several significant benefits. The egg can be properly represented to the consumer as a product with no additives or contaminants. Moreover, because it is not necessary to apply additional materials for purposes of the marking process, it is unnecessary to add the equipment needed contact the egg with a foreign substance. This greatly simplifies the task of performing the process inline in the production environment of an existing high-speed egg handling apparatus.

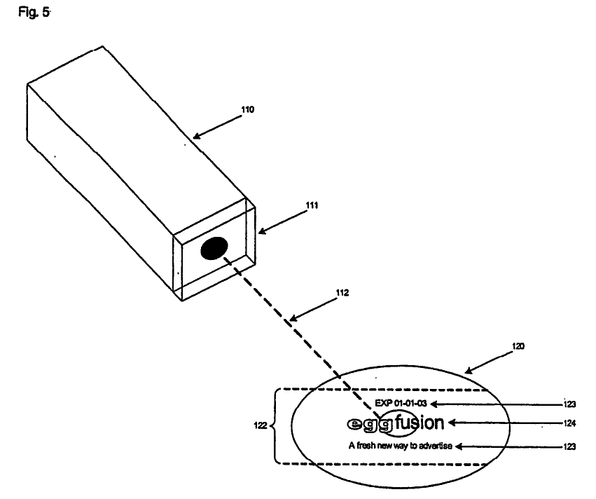

In a method according to an embodiment of the present invention, a radiant energy source 110 (FIG. 5) in proximity of an egg 120 directs radiant energy 112 towards the egg 120. Radiant energy source 110 desirably includes a laser such as a CO2 gas laser adapted to provide light at about 10.6 nm wavelength, at a minimum of 25 watts, and a projected maximum of 200 watts radiated power, in a beam projected of 0.020 inch to 0.120 inch at the surface of the egg. The beam is directed onto those areas of the egg, which are to be discolored and turned on and off so as to provide a series of pulses, the beam being “on” for about 20 milliseconds to 5 seconds during each pulse. During this pulsatile actuation, the beam is swept across those areas of the egg surface, which are to be discolored, so that successive pulses impinge on different spots on the egg surface. The spots typically are closely spaced or even overlapping, so that the discolored spots are perceived by the naked eye as a continuous discolored region. The sweeping motion may be performed in any manner which will provide the desired relative motion of the beam and the egg as, for example, by holding the egg stationary while moving the beam, moving the egg while holding the beam stationary, or moving both the egg and the beam. For example, the radiant energy source 110 may include a beam-sweeping unit 111 incorporating conventional optical elements such as movable or variable lenses, mirrors or prisms adapted to deflect the beam and to vary the deflection with time. Alternatively or additionally, the laser itself may be positioned on a movable platform, so that the beam can be moved by moving the laser. The laser may also be continuously applied, instead of in a pulsating application. One suitable radiant energy source is a laser of the type sold under the designation DSL-1 Series (in all available wattages) by the Domino Amjet and Domino Printing Company of Gurnee, Ill., U.S.A.

Radiant energy 112 is directed towards a target print area 122 of egg 120. Radiant energy 112 discolors egg 120 to form text 123 and graphics 124.

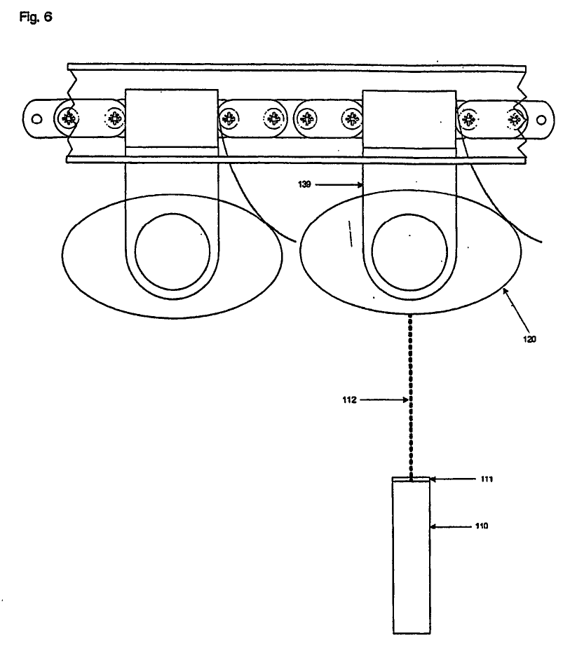

In a method according to an embodiment of the present invention, an egg moves through an egg-grading machine. An egg-grading machine grades the quality of the eggs, and may also transport the eggs towards a packaging machine. Egg-grading machines will move the egg along a path. Somewhere along the path, a predetermined region can be selected where the egg will pass through and radiant energy can form markings on the egg. Typically, as shown in FIG. 6, egg-grading machines have calipers 139 that hold the eggs at some point in the path of the egg-grading machine. The radiant energy source 110 may be placed in proximity to this point when the eggs are held so that the radiant energy 112 forms the markings on an egg 120 as it passes through this predetermined region. This eliminates any need for a special apparatus to position the egg. In this way the method is performed inline with the egg-grading machine. A beam-sweeping unit 111 may control the direction of the radiant energy 112.

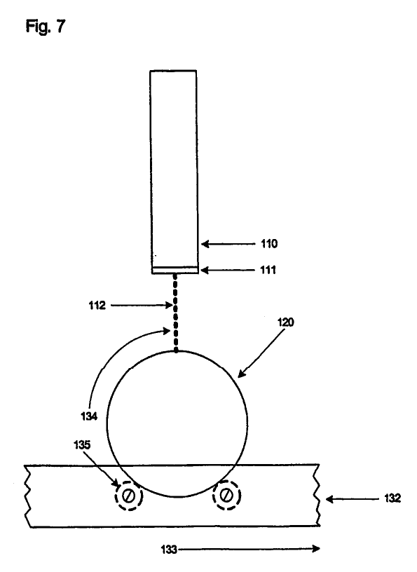

In another embodiment of the present invention, a radiant energy source may be placed in proximity of an existing egg-handling machine. Egg-handling machines includes any device or apparatus that will control the movement of an egg along a path, including egg-grading machines. The radiant energy source can be placed in proximity to the egg-handling machine so that the markings may be applied to the egg inline. In FIG. 7, the egg-handling machine moves an egg 120 along a conveyor apparatus 132. Conveyor apparatus 132 may include rollers 135, or some other form of conveyance such as the calipers discussion above, that moves egg 120 in a particular direction 133. Egg 120 will move along apparatus 132 in the direction 133 apparatus 132 is moving, and egg 120 may move in a rotational direction 134 on apparatus 132. Radiant energy source 110 is placed in proximity to conveyor belt 132 such that radiant energy 112 is directed towards egg 120. Beam-sweeping unit 111 can be used to compensate for the movement 133 of conveyor belt 132 and the rotation 134 of egg 120, so that the text and graphics can be applied to the egg 120.

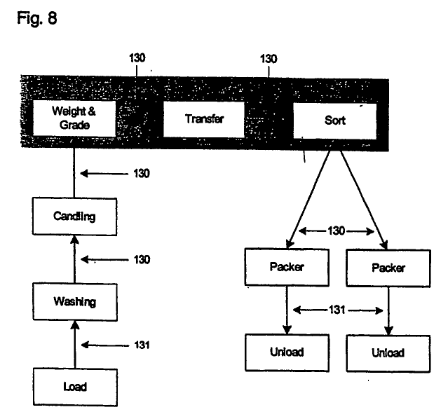

There are many variations of egg-handling and egg-grading machines. Most perform some common minimal basic functions. FIG. 8 is a block diagram outlining the basic functions of those machines. The eggs move through these machines while these basic functions are performed, and a radiant energy source can be placed inline 130 or offline 131 in between many of these functions to perform a method of the present invention. The eggs are loaded into the machine. An offline procedure may be performed after this function. The eggs are then washed, after which an inline method may be performed. The eggs are candled, after which an inline method may be performed. The eggs move to the grading portion of the machine where they are weighted and graded, after which an inline method may be performed. The eggs are then transferred to a sorter, before which an inline method may be performed. The eggs are then sorted by grades, after which an inline method may be performed. The eggs are placed into a package, after which an inline method may be performed. An offline process 131 can be performed prior to the load processor after the unload process and, typically involves human intervention or some other form of mechanical intervention alien to the egg-handling machine. In preferred embodiments of the present invention, the radiant energy source can be associated with an existing egg-handling machine without appreciably modifying the machine.

The radiant energy source may be connected to an input that can control the text and graphics. In one embodiment of the invention, the input is a computer. The computer can be used to enter the design of the advertisement, consisting of a tag line a logo, and the freshness date, to be applied to the egg. The design of the tag line, logo, and freshness date can be entered into the computer in many ways, including scanning an image into the computer, or using software to make the design. The computer then controls the radiant energy source or the beam-sweeping unit to apply the marking to the egg.

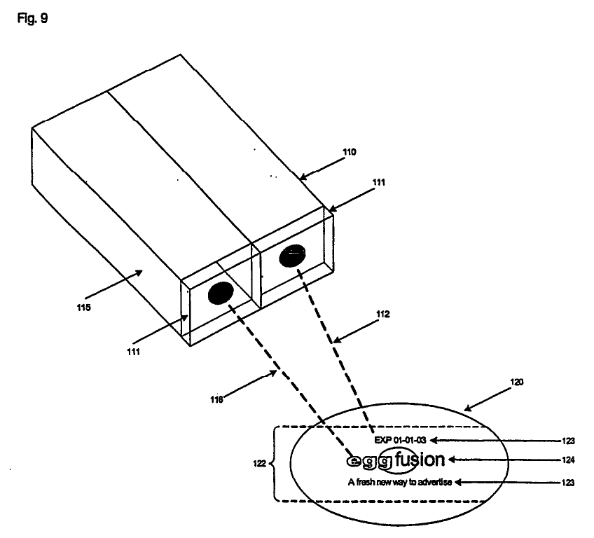

In FIG. 9, a method is shown where the markings are formed by a raster pattern. A radiant energy source 110 can apply radiant energy 112 such that one ray of the radiant energy is responsible for marking along one horizontal of the egg to form text 123, and another radiant energy source 115 provides radiant energy 116 that is responsible for the marking of graphics 124. This also can be done with one radiant energy source that emits multiple rays of radiant energy, or with any plurality of radiant energy sources that emit radiant energy.

While there has been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

The invention claimed is:

1. A method of marking an egg comprising: applying radiant energy to the shell of an egg so as to cause discoloration of the eggshell, thereby forming a marking.

2. The method as claimed in claim 1 wherein said radiant energy traces a marking selected from the group consisting of text and graphics.

3. The method as claimed in claim 1 wherein said marking on said egg includes an advertisement.

4. The method as claimed in claim 1 wherein said marking on said egg includes a freshness date.

5. The method as claimed in claim 1 wherein said marking on said egg includes an advertisement and a freshness date.

6. The method as claimed in claim 1 wherein said radiant energy is applied by a laser.

7. The method as claimed in claim 1 wherein said step of applying radiant energy is performed so as to leave some areas of the egg shell unaffected by said radiant energy, so said marking will have contrast with said unaffected areas.

8. The method as claimed in claim 1 wherein said markings are formed by said radiant energy source and the egg moves in a machine through a predetermined region.

9. The method as claimed in claim 1 wherein said marking is formed without use of a foreign material applied to the egg to form the marking.

10. A method of freshness advertising comprising:
applying an advertisement to an egg, and;
applying a freshness date to said egg.

11. The method as claimed in claim 10 wherein radiant energy is applied to the shell of an egg so as to cause a discoloration in the eggshell and thereby forming said advertisement and said freshness date.

12. The method as claimed in claim 10 wherein said advertisement and said freshness date are applied in one step.

13. Apparatus for applying markings on eggs comprising:
an egg-handling machine, and;
a radiant energy source located in proximity to said egg-handling machine, said radiant energy source being adapted to apply radiant energy so that the radiant energy-discolors the shell of the egg to form markings.

14. The apparatus as claimed in claim 13 wherein said egg-handling machine does not include structure for applying a radiant energy sensitive material to the egg.

15. The apparatus as claimed in claim 13 wherein said egg-handling machine is an egg-grading machine.

16. The apparatus as claimed in claim 13 wherein said radiant energy source is located such that said radiant energy will be applied inline.

17. The apparatus as claimed in claim 13 wherein said radiant energy source is located such that said radiant energy will be applied offline.

18. A method of modifying an egg-handling machine having a conveyance arranged to move eggs through a predetermined region, the method comprising:
arranging a radiant energy source in proximity to said egg-handling machine so that radiant energy from said source will impinge on eggs moved by said conveyance through said predetermined region.

19. A method as claimed in claim 18 wherein said method is performed without adding to said egg-handling machine any apparatus for applying a radiant energy sensitive material onto the eggs.

20. An egg, having an information-bearing marking thereon, said marking being formed at least in part by discolored material of the shell of said egg.

21. The egg as claimed in claim 20 wherein said marking is formed entirely by discolored material of the shell of said egg.

22. The egg as claimed in claim 20 wherein the egg is raw.

23. The egg as claimed in claim 20 wherein the egg is pasteurized but not cooked.

24. The egg as claimed in claim 20 wherein the egg is hard-boiled.
